(19) United States
(12) Patent Application Publication
(10) Pub. No.: US 2016/0129415 A1
(43) Pub. Date: May 12, 2016

(54) MULTIPLEX CHEMOTYPING MICROARRAY (MCM) SYSTEM AND METHODS

(71) Applicants: Hoi-Ying N. Holman, Oakland, CA (US); Sun Choi, Seoul (KR); Giovanni Birarda, Trieste (IT); Liang Chen, Walnut Creek, CA (US)

(72) Inventors: Hoi-Ying N. Holman, Oakland, CA (US); Sun Choi, Seoul (KR); Giovanni Birarda, Trieste (IT); Liang Chen, Walnut Creek, CA (US)

(73) Assignee: THE REGENTS OF THE UNIVERSITY OF CALIFORNIA, Oakland, CA (US)

(21) Appl. No.: 14/835,580

(22) Filed: Aug. 25, 2015

Related U.S. Application Data
(63) Continuation of application No. PCT/US2014/018810, filed on Feb. 26, 2014.
(60) Provisional application No. 61/769,711, filed on Feb. 26, 2013.

(51) Int. Cl. B01J 19/00

(52) U.S. Cl. CPC B01J 19/0046; B01J 2219/00587; B01J 2219/00605; B01J 2219/00385; B01J 2219/00704

(57) ABSTRACT

A Multiplex Chemotyping Microarray (MCM) system and methods are herein described. The MCM system and methods enable rapid chemical analyses of heterogeneous mixtures, by combining high-throughput micro-contact printing technology with high-fidelity (mass) vibrational spectroscopy. The MCM enables an error-free deposition and detection of multiple chemicals in a heterogeneous liquid sample at a throughput of more than two orders of magnitude beyond existing methods.

### CROSS-REFERENCE TO RELATED APPLICATIONS

This application is a continuation of and claims priority to International Patent Application No. PCT/US2014/018810, filed on 26 Feb. 2014, which is a continuation and claims priority to U.S. Provisional Patent Application No. 61/769,711, filed on Feb. 26, 2013, both of which are hereby incorporated by reference in their entirety.

### STATEMENT OF GOVERNMENTAL SUPPORT

This invention was made with government support under Contract No. DE-AC02-05CH11231 awarded by the U.S. Department of Energy. The government has certain rights in the invention.

### BACKGROUND OF THE INVENTION

1. Field of the Invention

The present invention relates to the field of contact printing, and more particularly to pico-liter droplet printing and printing heads. The present invention also relates to methods of contact printing for sample preparation and high-throughput screening using vibrational spectroscopies, with downstream absorption/emission spectroscopy, and mass spectrometry

2. Related Art

The increased promise of developing cost-effective bioenergy solutions from lignocellulosic biomass has brought the generation of tens of thousands of natural and induced variations in energy crops weekly, and a widespread need of rapid and high throughput and large-scale analytical methods to screen for the promising ones. Targets of analysis include contents of cellulose, lignin, hemicellulose, pectin and other cell wall components; and the structure and extend of cellulose crystalline. One common analytical technology is the use of mid- or/and near-infrared spectroscopy to identify, to quantify, and to assay the plant cell wall composition of the plant starting as well as ending materials. The quality and accuracy of measurements of materials, however, criticially affected by the quality of sample preparation. For example, current practice in plant-biomass sample preparation for infrared spectroscopy analysis is time consuming with significant quality variations because of the heterogeneity and lack of reproducibility in the sample preparation, making it almost impossible to be used in rapid and high throughput methods. Current widely used sample preparation protocols for infrared spectroscopy measurements, such as the KBr pellet approach, are very time-consuming, and and with physical properties (e.g., particle size, sample thickness and geometry) which vary and therefore affect infrared signal intensities and spectral features. Other barriers to high-throughput FTIR analysis of samples include that intact samples have limited penetration—only the epidermis is seen when examining intact leaves and stems, and there is spatial variation—and data analysis.

One of the inventors and others reported on a high-throughput method, but limited to a single sample loading, to create size-tunable micro/nanoparticle clusters via evaporative assembly in picoliter-scale droplets of particle suspension in Choi S, Jamshidi A, Seok T J, Wu M C, Zohdi T I, Pisano A P, Fast, high-throughput creation of size-tunable micro/nanoparticle clusters via evaporative self-assembly in picoliter-scale droplets of particle suspension, Langmuir, 2012 Feb. 14; 28(6):3102-11. doi: 10.1021/la204362s. Epub 2012 Feb. 2, hereby incorporated by reference in its entirety. Mediated by gravity force and surface tension force of a contacting surface, picoliter-scale droplets of the suspension were reported as generated from a nanofabricated printing head. In Choi et al, the multiplexed printing refers to the loading and printing of an array of one sample at a time. Thus, there is a need for contact printing of thousands of samples on a single substrate at one time.

The challenges to be overcome by the present invention are speed, high throughput scaling, reproducibility, and printing hundreds to thousands of samples in seconds.

### BRIEF SUMMARY OF THE INVENTION

The present invention provides a system and methods of preparing samples in a standardized and reproducible form for high-throughput screening. A porous membrane printing head array, necessary for sample transfer, is described and fabricated by applying conventional micro-electromechanical systems (MEMS) technology. The present porous membrane printing head array and methods enable multiplexed printing, i.e., loading and printing of thousands of samples at one time.

In various embodiments, a method for preparing sample materials and screening and characterizing sample components using mid- and near-infrared spectroscopy and spectromicroscopy (also called microspectroscopy). The methods described herein provide the ability to quickly and comprehensively identify multiple chemicals and their chemical and molecular structure in solid, liquid, or gel phases (i.e., simultaneous multi-sample screening rate). The methods provide for high throughput, precise identification of chemical molecular structures, with diverse sampling capability. Thus, a method providing a serial printing procedure having steps comprising. (i) Fluid menisci are extruded to the pores of a membrane driven by gravity. (ii) Full contact of the head with the substrate is achieved. (iii) Surface tension force of the substrate attracts a fraction of the fluid. (iv) picoliter-scale droplets are transferred to the substrate via the pinch-off processes. (v) Rapid evaporative self-assembly of the particles forms a 3D structure. A In some embodiments, schematic diagram of a global printing system required for aligning the printing head with the optical substrate. A printing head is attached to the printing system.

In some embodiments, the method will, in a rapid and high throughput manner, standardize all potential parameters in a routine sample preparation for reproducible and accurate vibrational spectroscopy analysis of samples with minimal to no processing. The present methods provide for a sample population with minimum variations, and wherein such variations are minimized by standardizing these parameters.

Samples can be mixtures of particles (e.g., plant particles, airborne particulates, soil particles, microorganisms, cells, etc.) with dimensions up to tens of micrometers, viscous solutions, concentrated mixtures of proteins or heterogeneous biomolecules (e.g., semen, blood serum or cell lysates). For example, a sample of crude biomass or plant materials is processed and suspended in liquid with minimal preparation and the present systems and methods provide for depositing the bioenergy plant materials sample on a substrate thereby allowing high throughput screening and characterizing of energy crop cell wall components using mid- and near-infrared spectroscopy and spectromicroscopy (also called microspectroscopy).

In some embodiments, the parameters that are standardized include but are not limited to, concentrations of plant cell wall materials, particle size of milled/ground plant materials, water content in milled/ground plant materials, qualitative and/or quantitative variations in the (milled) plant matrix, sample shelf-age, temperature, carrier matrix: liquid (e.g., water, organic solvents, mineral oil, etc); solids (e.g., infrared crystal powder such as but not limited to KBr powder).

In another embodiment, the present invention provides for a system comprising a printing head fabricated by applying conventional MEMS technology to silicon substrates for high throughput printing of samples onto a substrate. Holes of the printing head are defined by photolithography and followed by dry and wet etching. Direct contact of the head with the substrate transfers multiple picoliter (20 μL˜200 μL) droplets of particle suspension to the substrate. In one embodiment, the transfer of particle suspensions is gravity-surface tension driven only. In other embodiments, the transfer of particle suspensions is power-driven.

The present system and methods can facilitate simultaneous detection (i.e., within one testing sample) of most known chemical classes, as well as provide molecular identification while testing for over a thousand samples per disc—a bio-analytical power previously unknown. Furthermore, the present system and methods allows the testing of samples with picoliter precision and the production of reproducible and accurate results in a short period of time. This means that substantial high-volume chemical molecular analyses can be conducted routinely—enabling scientists and bioengineers to track, as never before, for example, the evolution of metabolic processes and functions of a certain organism, plant or microbe over a short period of time.

### BRIEF DESCRIPTION OF THE DRAWINGS

FIG. 1 shows a current overview of a typical prior art near infrared assay for cell wall composition.

FIG. 2 shows that Vogel et al. demonstrated that SR-FTIR analysis was used to find the powdery mildew resistant mutant and that those mutants have less pectin in their cell walls.

FIG. 3 shows a high throughput infrared-screening protocol for samples such as bioenergy crop particles. A flow diagram is shown for performance evaluation and applications.

FIG. 4 is a schematic diagram of the present steps in the method and system. The system's device carries out three steps which are shown in the inner box. The device and procedure are shown together are in the outer larger box. After preparation and printing of the samples on the substrate, infrared spectroscopy/spectromicroscopy and analysis are carried out on the samples.

FIGS. 5A through 5E shows a printing head design for use in the present methods and system. FIG. 5A shows the photomask designs for photomask #1, photomask #2 and a closeup view of photomask #2. FIG. 5B shows magnified top-view of one of the porous membranes that comprises the wafer-scale printing head array. FIG. 5C shows a schematic of the wafer-scale printing head array, with a magnified view of one of the porous membranes relative to the array. Also shown is the top view of four pores in the porous membrane. The bottom panel shows the printing head with the wafer-scale printing head array, and the reservoir opening on the front side of the printing head. FIG. 5D shows the layout of the pore structures. FIG. 5E is a schematic showing sample loading for natural accession printing. FIG. 5F is a schematic showing sample loading for mutation printing.

FIG. 6A illustrates a general procedure of processing a sample and printing micrometer-scale particle clusters on an optical substrate for multiplex and spectral analysis. FIG. 6B shows the wafer-scale printing head array adjacent to part of the printing head, an optional optical alignment system, and an alignment system having a holder, a 3-axis position stage.

FIGS. 7A-7C are schematics showing a side view of the printing head during printing in cut out view of the pore. FIG. 7A shows Steps 1 where the sample droplet is extruded through the pores of the printing head. Step 2, the printing head contacts or allows the droplets to contact the substrate. FIG. 7B shows Step 3, where the sample droplet is released onto the substrate. In Step 4, evaporation of the liquid in the sample occurs leaving the sample on the substrate ready for analysis. FIG. 7C shows a substrate with the sample discs deposited on the substrate.

FIG. 8 shows the high-throughput screening protocol including the sample evaluation steps. For some samples, the sample preparation and evaluation steps may not be required.

FIGS. 9A and 9B show two grinding optimizations at room temperature (FIG. 9A) or by cryogenic (FIG. 9B) preparation.

FIG. 10 shows the SR-FTIR and SEM images which confirm the high-quality sample preparation provided by HTMM (also called MCM).

FIGS. 11A, 11B and 11C show semi-quantitation of biomass components obtained by FTIR spectra univariate analysis.

FIG. 12 shows graphs and high throughput multivariate screening analysis of the obtained FTIR spectra and interline variations.

FIG. 13 shows a list of T-DNA lines for FTIR chemochemotyping.

FIG. 14A shows protein pattern obtained HTMM (or MCM) and FIG. 14B shows vibrational spectra obtained by ˜1 pg of BSA.

FIG. 15 shows the high-throughput printing head with corresponding droplet arrays.

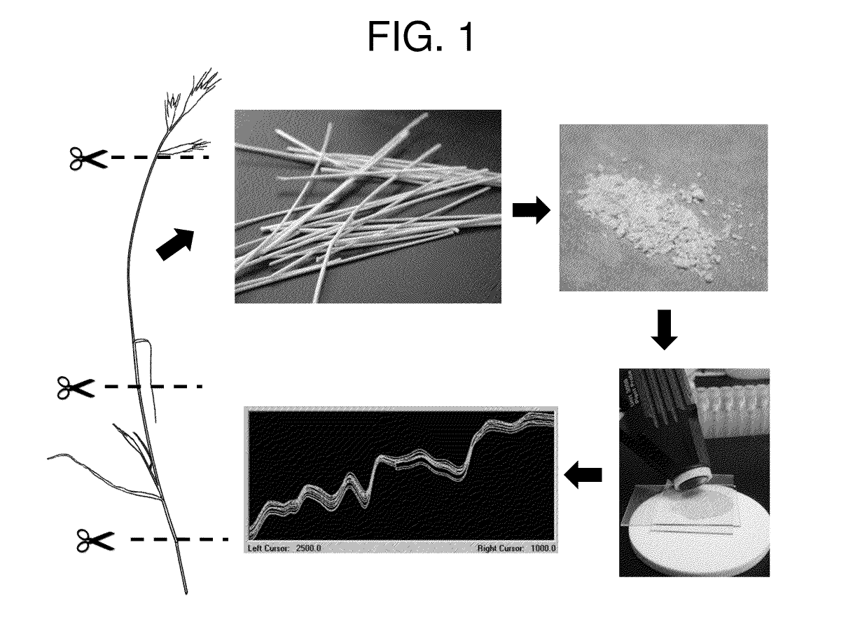

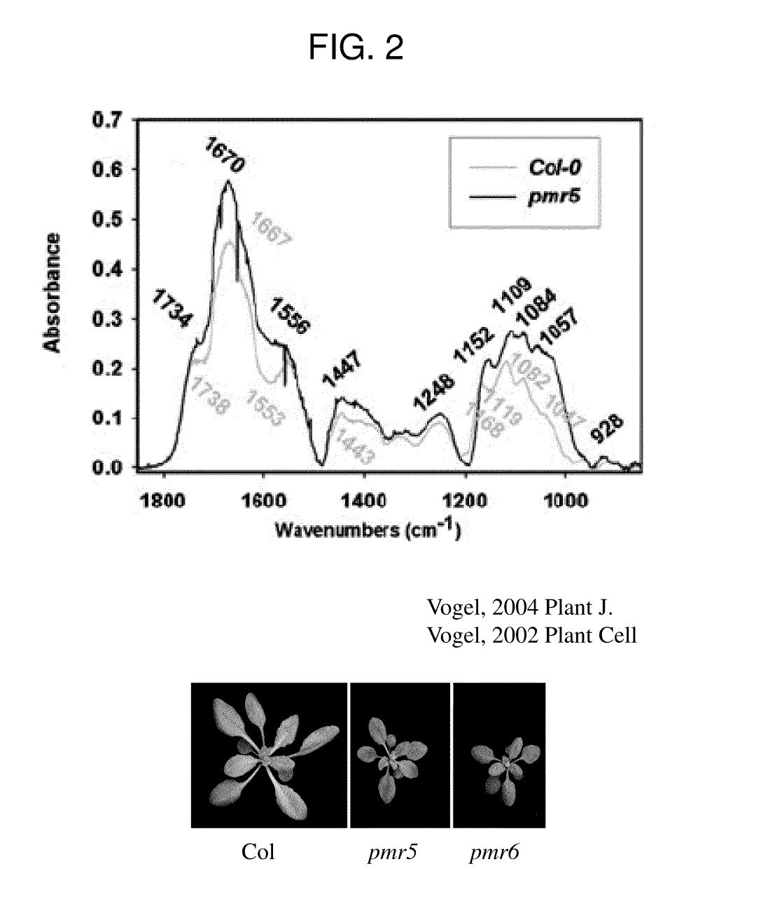

### DETAILED DESCRIPTION OF THE PREFERRED EMBODIMENT

### Introduction

Crude biomass, plants and other heterogeneous mixtures are very difficult experimental subjects. High throughput methods to measure cell wall composition such as by chemotyping require methods of how measure cell wall components. Methods such as infrared spectroscopy can provide such analysis. NIR spectroscopy is rapid, but not quantitative without an established model and FTIR is semi-quantitative, but low throughput due to sample preparation. The present Multiplex Chemotyping Microarray (MCM) methods and system are used to provide for high throughput FTIR spectroscopy screening.

### Descriptions of the Embodiments

In one embodiment, a system comprising a printing head array, fabricated by applying conventional MEMS technology to substrates, for high throughput array printing of samples onto a substrate. In another embodiment, methods for preparing sample materials and screening and characterizing sample components using mid- and near-infrared vibrational spectroscopy and spectromicroscopy (also called microspectroscopy) are described. The methods described herein provide the ability to quickly and comprehensively identify multiple chemicals and their chemical and molecular structure in solid, liquid, or gel phases (i.e., simultaneous multi-sample screening rate). The methods provide for high throughput, precise identification of chemical molecular structures, with diverse sampling capability.

In various embodiments, suspensions of samples (e.g., biological particles or cells or polymers or other mixtures) are loaded and injected into the print-head well array. When suspensions are loaded into the wells of the print head, the surface tension of the suspension in the printing head well form numerous micrometric meniscuses. Meniscuses of sample droplets extrude to the front of the print head within a second via gravity. The printing heads are brought in contact with the MCM plate for 5-10 seconds, and multiple picoliter sample droplets are transferred to the MCM plate. The hydrophobic surface of the MCM plate enables unprecedented rapid droplet evaporation, leading to a three-dimensional self-assembly structure of biological particles or macromolecules through colloidal crystallization by controlled capillary evaporation. In nature, particle sizes in samples can vary greatly, depending on the samples and the materials in the samples. MCM's fast and controlled self-assembly by capillary evaporation enables particle self-arrangement of varying dimensions into tightly packed cone-shaped clusters, owing to automatic filling of smaller particles into the space between larger particles. This further enhances the geometric uniformity and reproducibility of sample particle clusters.

MCM Device and Procedure:

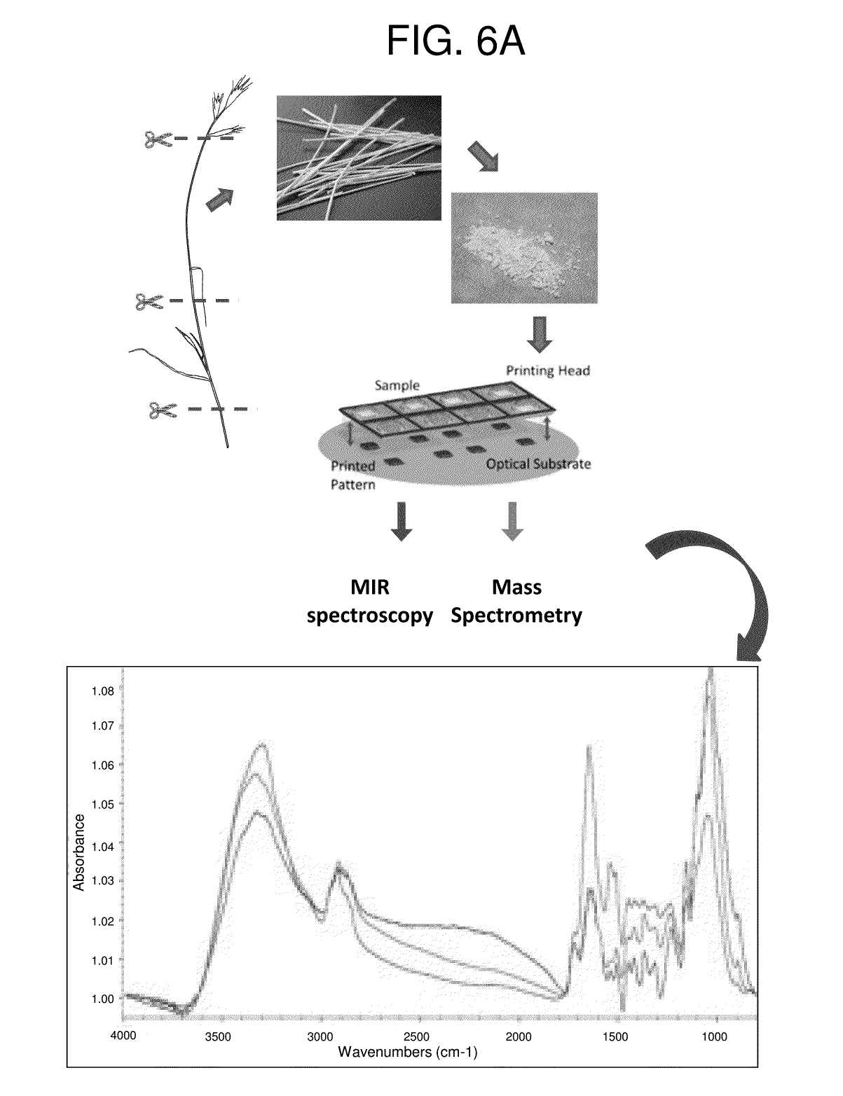

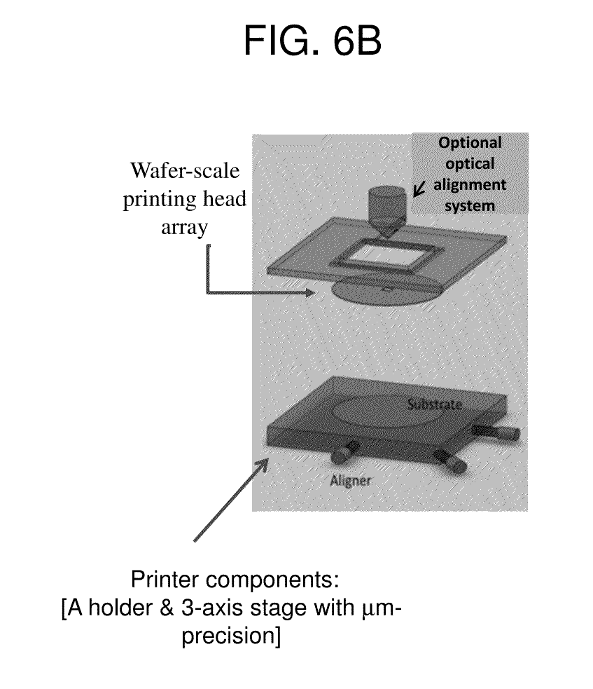

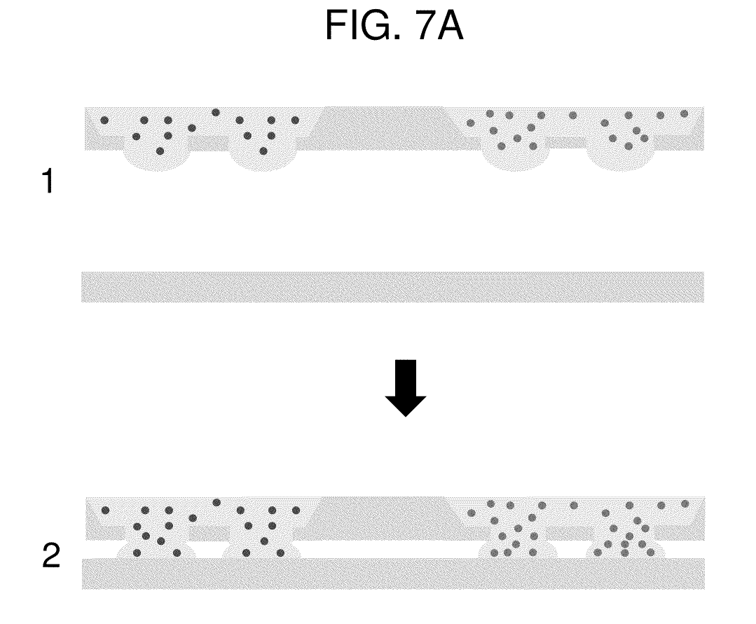

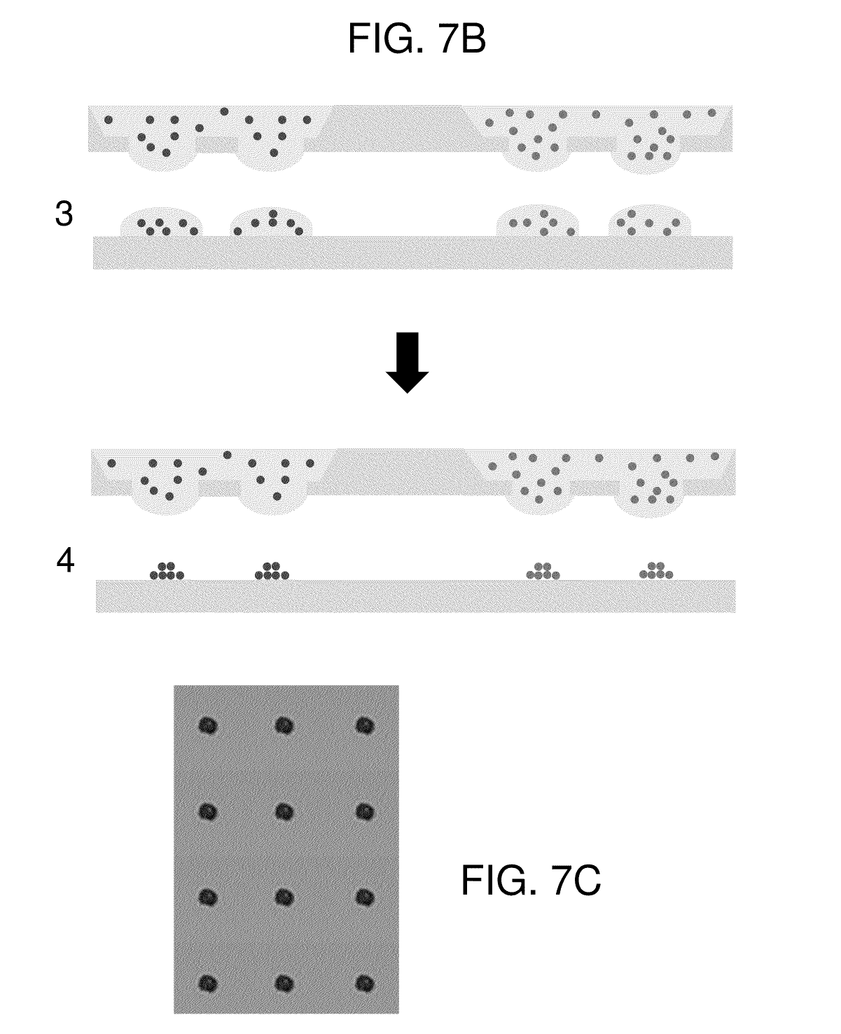

Referring now to FIGS. 6A and 7A-7C, in one embodiment, a general procedure of printing micrometer-scale particle clusters is carried out using a printing head array which prints the array of samples onto an optical substrate.

In various embodiments, the MCM device comprises (1) an array of silicon-based micro-fabricated pores (each pore also referred to herein as a printing head), generated and arranged in patterns by photolithography and reactive-ion-etching, and necessary for sample reproduction; (2) an optical measurement substrate with a hydrophobic surface (also referred to herein as an “MCM plate”); and (3) an actuator (i.e., control mechanism) that brings the printing heads in contact with the optical substrate's surface.

In some embodiments, the printing head array is comprised of a wafer-scale substrate having pores. The printing head array can be comprised of silicon, any inert metal or alloys, or any rigid polymer. In some embodiments, the printing head array is fabricated by applying conventional MEMS technology to silicon substrates. In some embodiments, the printing head is silicon substrate comprised of silicon and silicon nitride to maintain the rigidity.

In various embodiments, the dimensions and geometry of the pores or holes of the printing head array are at least 2 μm to hundreds of nanometer size. In some embodiments, the pores are 10-20 μm, 20-40 μm, 40-60 μm, 60-80 μm, or 80-100 μm in size. In other embodiments, the pores are 100-200 μm, 200-500 μm, 500-1000 μm in size. The spacing between the pores can be variable depending upon the size of the sample cluster needed. In some embodiments, the spacing is 400 μm to 500 μm, or greater distance apart. In some embodiments, the pore or holes of the printing head array are defined by photolithography and followed by dry and wet-etching. The backside is wet-etched in order to define an array of reservoirs to contain particle suspensions. After the final etching step, a microporous membrane with hundreds-nanometric thickness is released on the head. The printing head array should be mechanically robust and should not break by fluid rinsing and air blowing. In some embodiments, the printing head array can be attached to the mask holder of conventional UV-exposure system.

In some embodiments, the optical substrate is comprised of silicon, metal or alloys, or other substrate. In various embodiments, the optical substrate is comprised of materials or coated with materials and is mid-infrared transparent or reflective.

In one embodiment, the optical substrate and printing head can be comprised of polymeric materials coated with a mid-infrared light reflective coating. For example, a polymer optical substrate can be coated with a thin layer of chromium or titanium for adhesive purpose, then a thin layer of gold, aluminum, or silver, etc. An outer thin layer of hydrophobic materials can be deposited or added to the substrate.

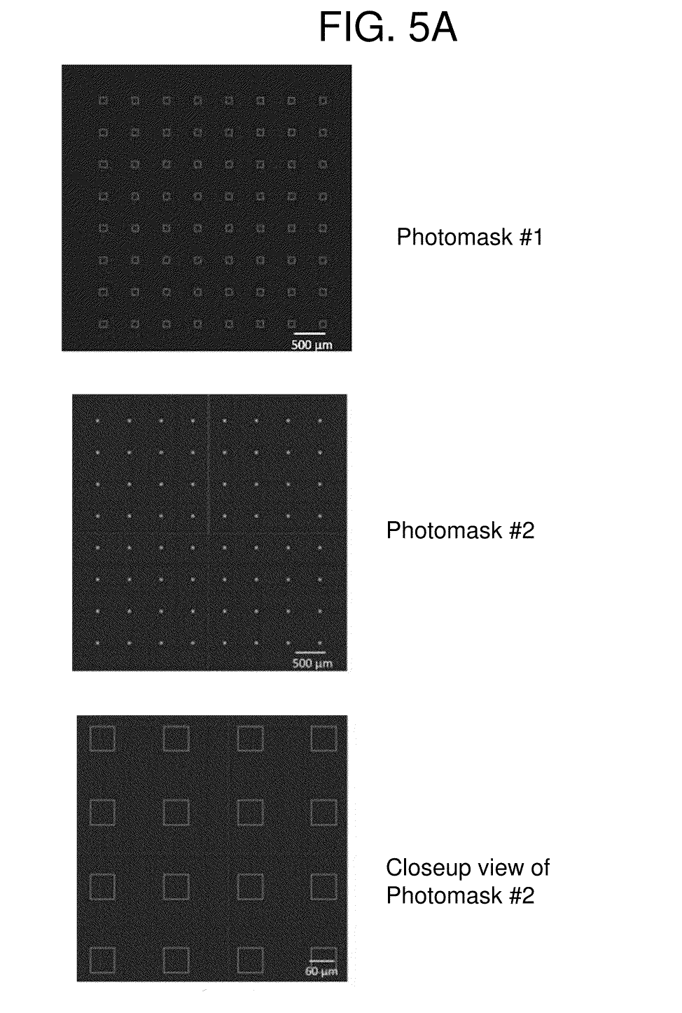

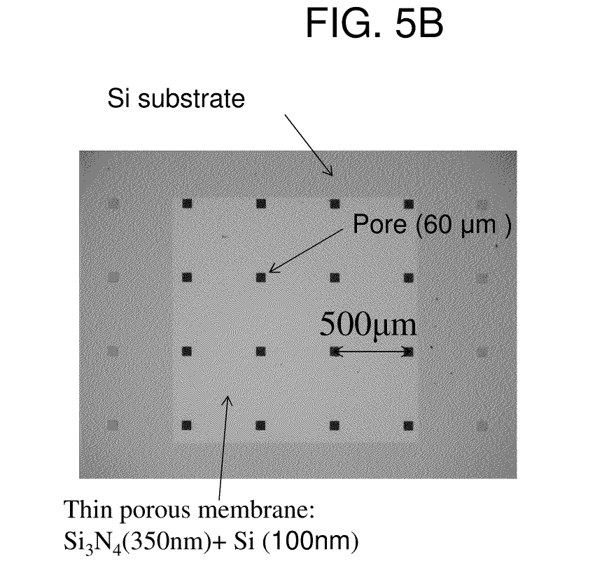

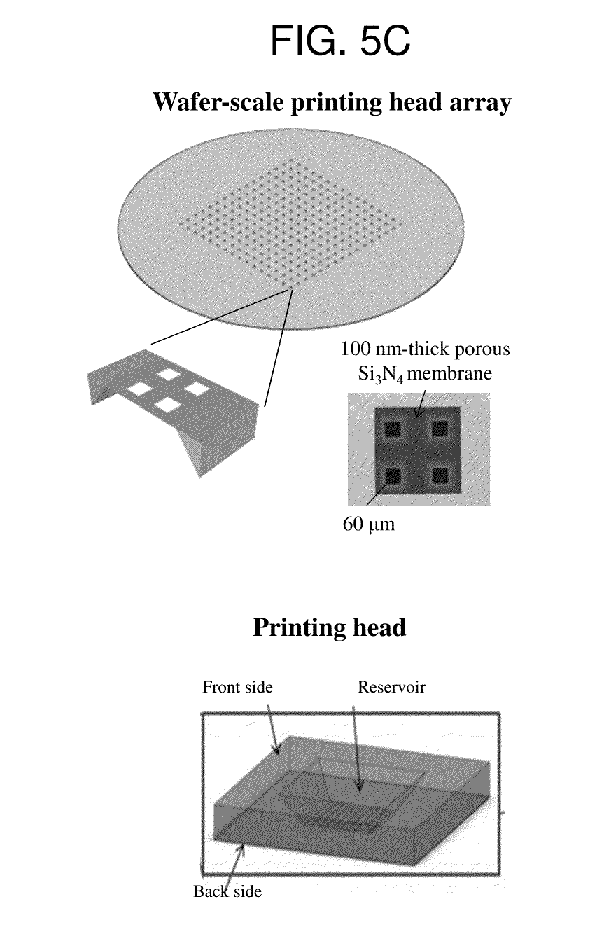

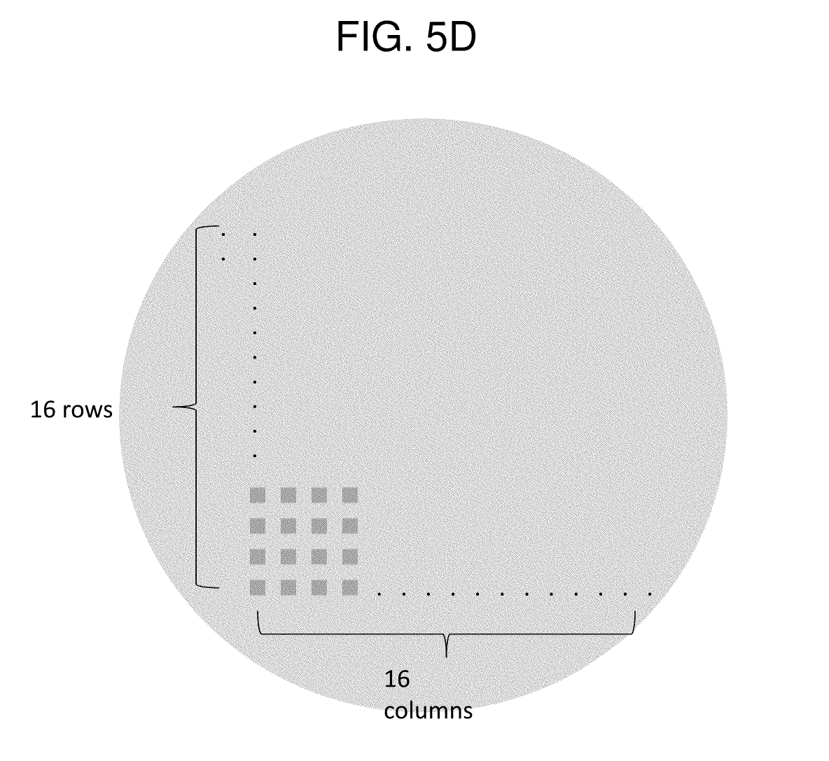

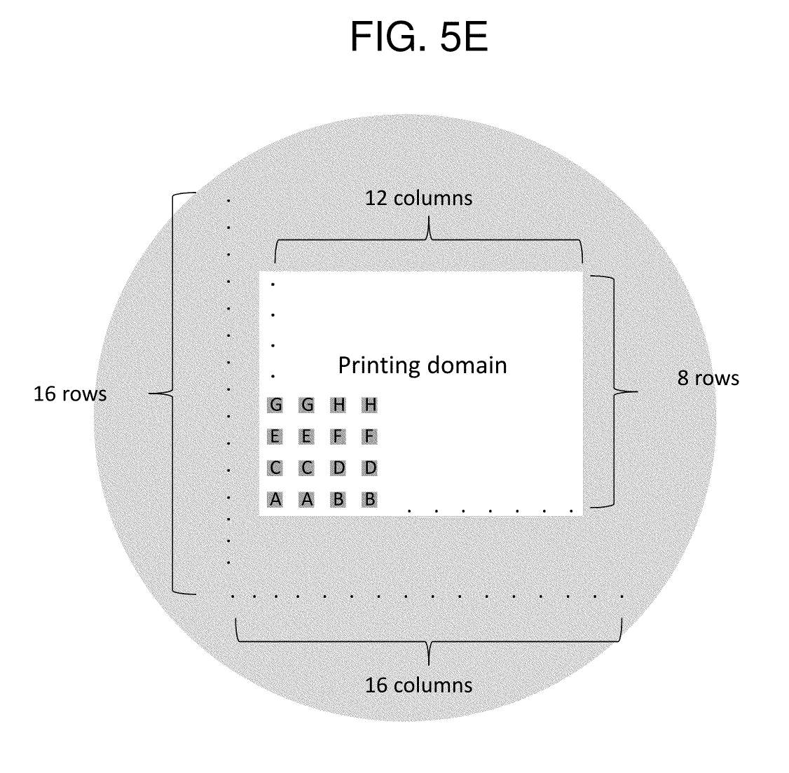

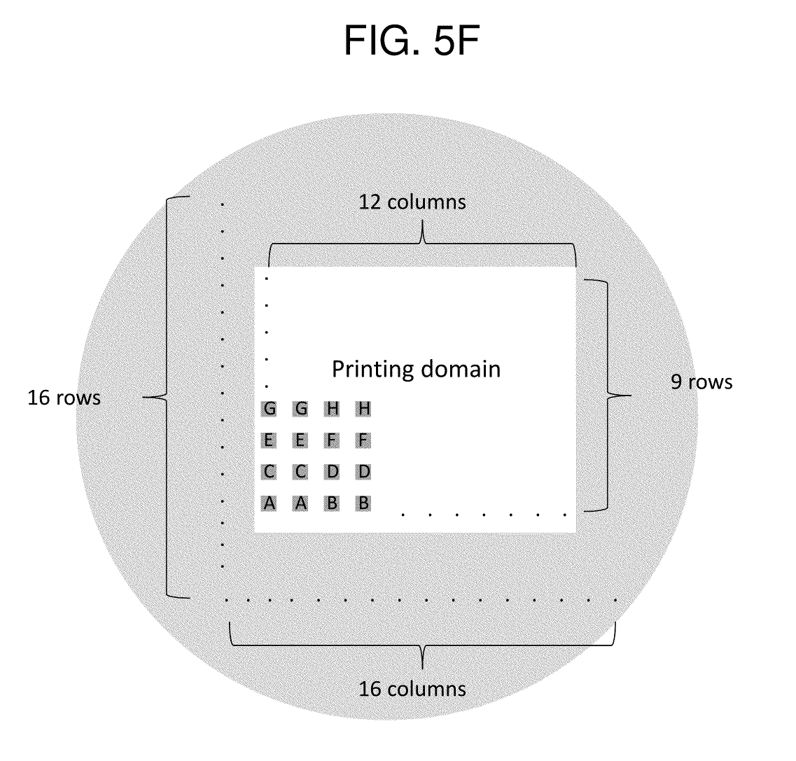

The printing head design controls the final pattern feature and dimension of the samples printed onto the optical substrate. In one embodiment, the pico-liter droplet covers about 50 μm×50 μm area. The printing heads and number of reservoirs can be sized according to the high throughput needs. In various embodiments, the number of reservoirs and printing heads can be up to 1024 droplets (e.g., 256 reservoirs with 4 droplets in each pattern, see FIGS. 5D-5F) that can be stamp printed. In some embodiments, the array of droplets can be stamp-printed in less than 5-10 seconds.

In some embodiments, the optical substrate surface is treated to increase hydrophobicity. Hydrophobic materials can be coated or deposited on to the substrate surface (e.g., by chemical vapor deposition) as is known in the art. Suitable materials include but are not limited to fluoroctatrichlorosilane (FOTS), Teflon, or any other kind of hydrophobic material may be suitable.

In various embodiments, the system further comprising a means for aligning the printing head and the optical substrate. In one embodiment, a fabricated metal seat fitted to the optical substrate may be used. In another embodiment, an optically guided or visual alignment system is used to align the printing head and the optical substrate during printing. In another embodiment, a manual or sensor seated positioner is used. In another embodiment, a micron-precision, three-axis stage controller of the printing system places the printing head to the targeted area, by the optics.

Three steps are involved in the MCM sample printing process (following the loading) and operation theory:

A. Before contact printing: When droplet is extruded from the membrane through pore, before it touches the optical substrate plate, its forces are balanced between gravity and friction force across the membrane sums surface tension of the meniscus.

B. During contact: Once the droplet meniscus touches the substrate, the pressure sensor that is embedded in the optical substrate plate senses the exerted pressure and pulls the printing head back upward. During the short time period of droplet touching the substrate, the spacing gap between the head and the substrate acts as a capillary channel, so that the droplet meniscus can be easily squeezed out from the reservoir. The gap is estimated to be the half of the diameter of the droplet. When the droplet touches the substrate, the surface tension of the substrate, is added to the original force balance and attracts a fraction of the droplet and allocate it to the substrate.

C. After contact: After the droplet is transported to the substrate, the particles in the droplet assemble in the center and form the cluster. This assembly is governed by inter-capillary forces that are driven by evaporation of the medium.

Referring now to FIGS. 7A-C, printing using the present printing head array relies on gravity, surface tension and evaporative assembly. FIG. 7A shows Steps 1 where the sample droplet is extruded through the pores of the printing head. After loading the suspension to the head (e.g., 0.1 μL˜10 μL), meniscus of the droplet extrudes to the front of the head within a second by gravity. Step 2, the printing head contacts or allows the droplets to contact the substrate. Direct contact of the head with the substrate transfers multiple picoliter (e.g., 20 pL˜200 pL) droplets of particle suspension to the substrate. FIG. 7B shows Step 3, where the sample droplet is released onto the substrate and the printing head is drawn back from the optical substrate. The hydrophobic property of the optical substrate encourages the sample droplets to bead up and not disperse. In Step 4, evaporation of the liquid in the sample occurs leaving the sample on the substrate ready for analysis.

In some embodiments, the whole printing process takes less than 5 to 10 seconds. Compared to the sample-KBr mixture pellet method or conventional inkjet printing, this printing technology generates smaller and more homogeneous patterns of micrometer-scale micro/nanoparticle clusters. Precise control over the volume of dispensed suspension droplets in picoliter-scale and fast clustering of different sized-particles during rapid evaporation of the suspension droplets enable the printing of high-throughput, micrometric, closely packed clusters of heterogeneous particles. The fast clustering of different sized-particles is achieved through evaporative self-assembly of the particles into tightly packed cone-shaped clusters due to automatic filling of smaller particles into the space between larger particles, which further enhances the geometric uniformity of sample particle clusters.

In some embodiments, the system further comprises a pressure sensor to detect the pressure of the printing head exerted on the substrate.

In other embodiments, the system further comprising a means for control of the humidity in the space or air gap between the printing head and the optical substrate.

In some embodiments, bright-field visible imaging is used to obtain morphological and phenotypic information on the sample of each of the structured clusters on an MCM plate

In other embodiments, to enable hydrodynamic pressure-driven printing, a transparent cover will be placed on top of the printing head holder and the cover will have a hole that is connected to a vacuum pump. If the pump pressure is applied, there will be hydrodynamic back pressure applied to micrometric meniscus and the meniscus will be extruded more. If the printing is performed after the pressure is applied, the resolution of the printing will be enhanced.

A manual or a fluidic micro-actuator (pneumatic or hydraulic) can be applied to control the deposition of the liquid samples onto the optical measurement substrate.

In some embodiments, the MCM technique can be used as a sample concentration mechanism. For example, for low concentration or very dilute samples, repeated contact printing can be performed for the purpose of sample concentration in each spot. Multiple evaporative assembly of the sample leads to sample concentration. Referring to FIG. 7B, Steps 3 and 4 are repeated multiple times.

Procedure Development and Demonstration:

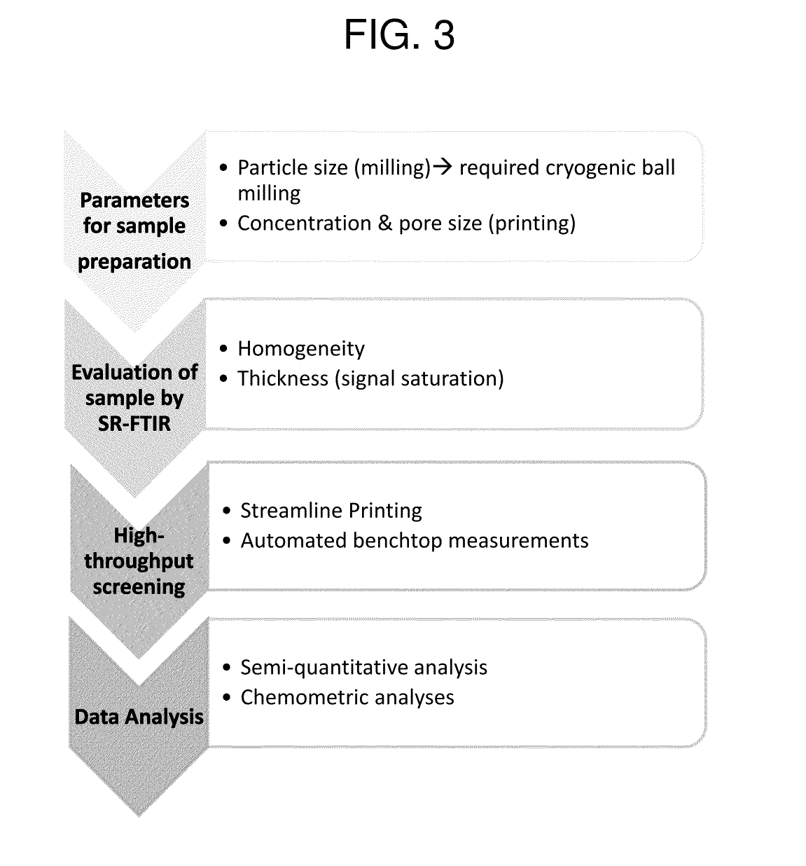

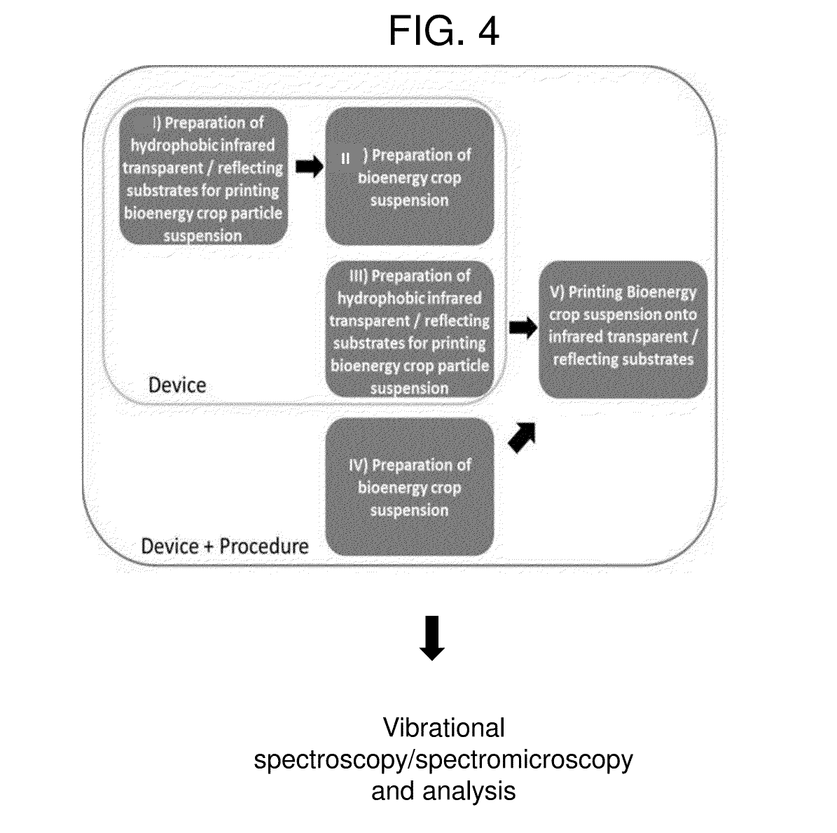

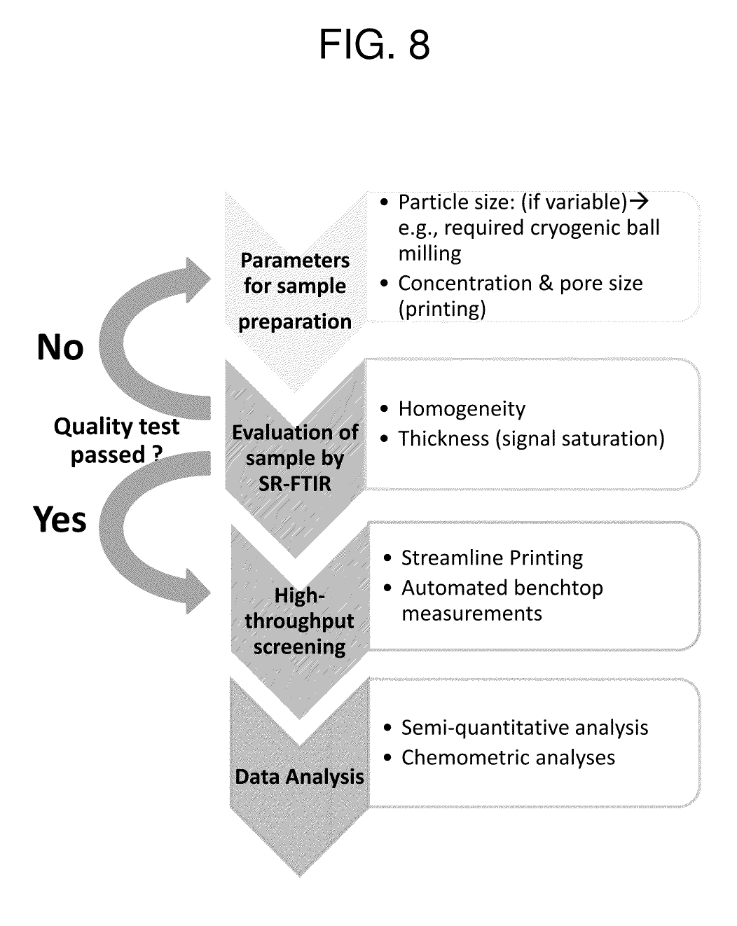

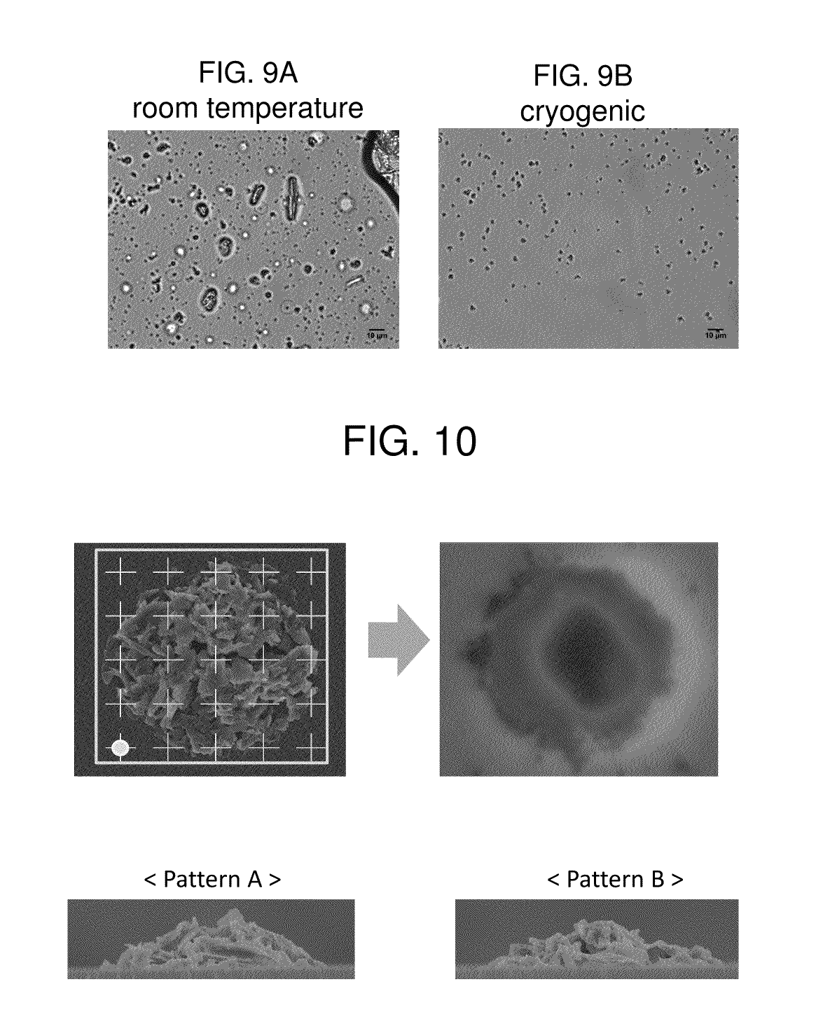

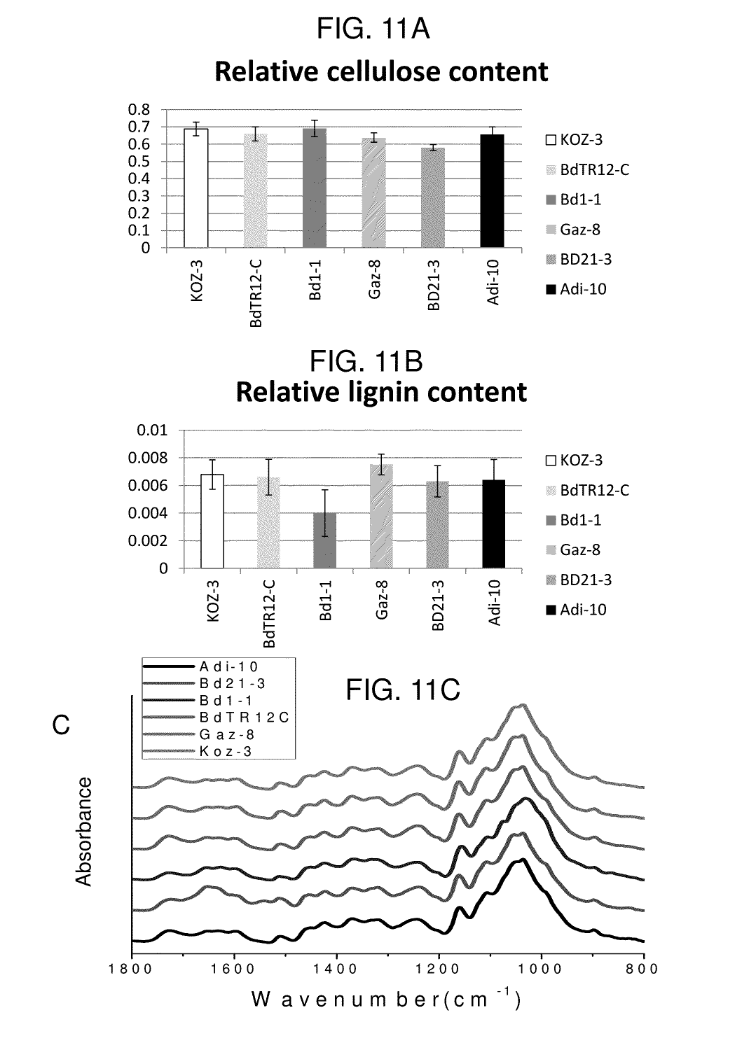

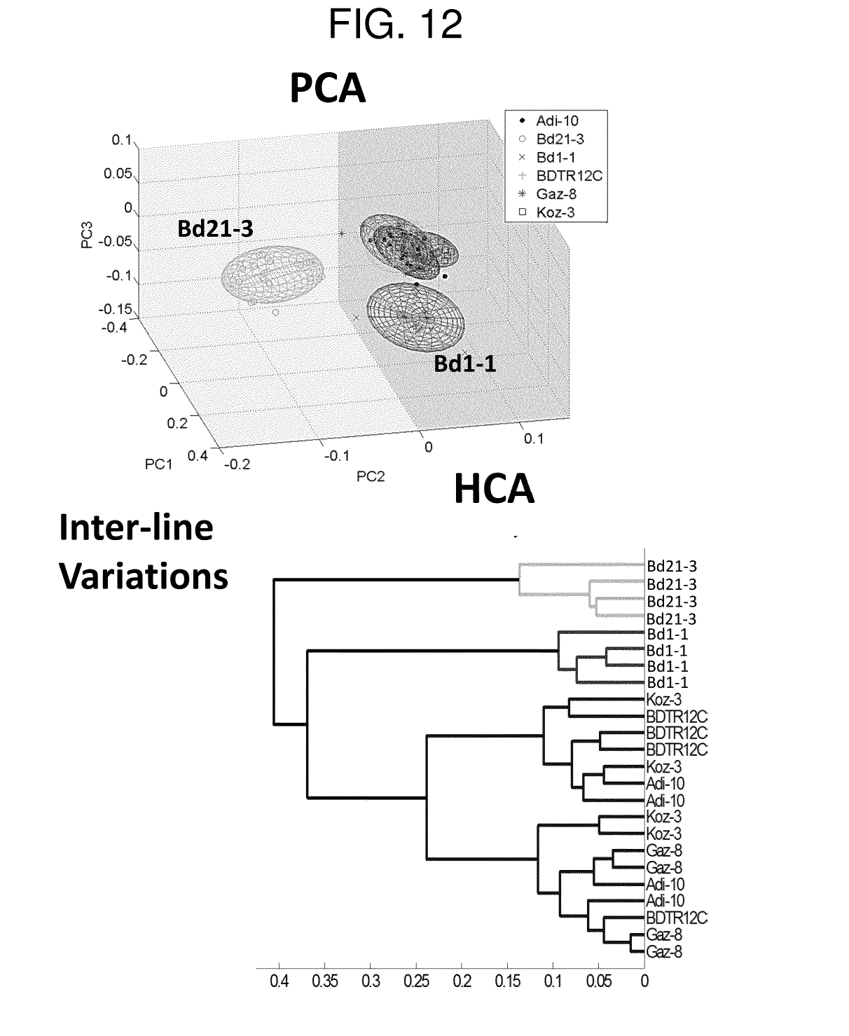

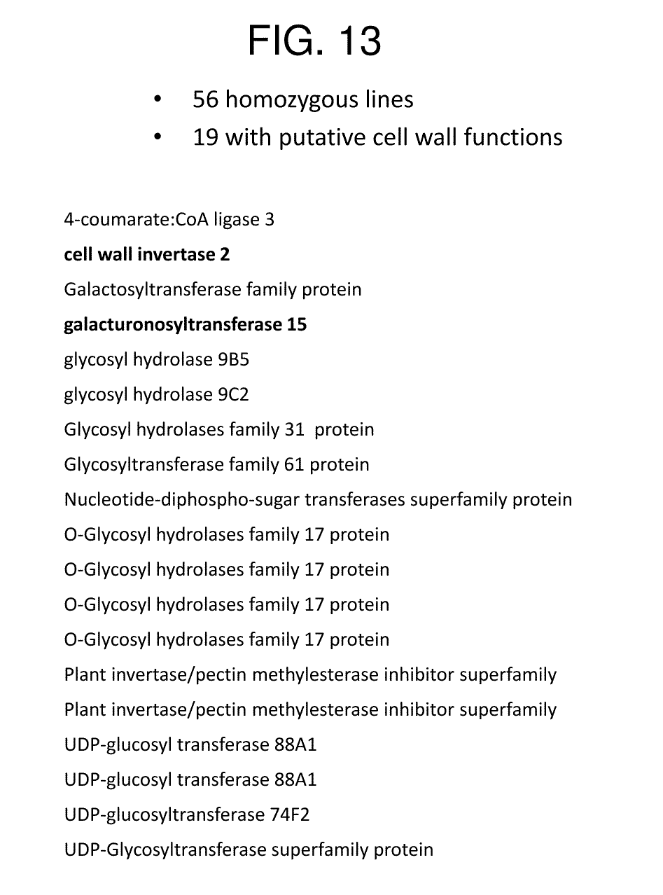

An example of a high-throughput screening protocol of biomolecules is illustrated in FIG. 3. Referring to FIG. 8, the evaluation/optimization is recursively iterated by changing the input parameters until the outcome meets pre-determined criteria. After the optimization of the parameters, high-throughput printing of various sample powders is performed. Optimal parameters for biomolecule or nanoparticle printing such as the milling/grounding parameters (speed, temperature, duration, vessel materials), carrier fluids/solids, concentration of the sample in carrier fluid or solid or mixture of fluid and solid), and pore size of the printing head are identified by infrared spectroscopy of the printed patterns are optimized first as shown in FIG. 9 and standardized before high-throughput screening is performed. FIG. 9 shows the grinding optimization round at room temperature or by cryogenic preparation. FIG. 10 shows the high-quality achieved after the procedure of parameters optimization. In some embodiments, the methods further comprise optimization of micrometer size of the clusters and the thickness of the sample clusters after the sample droplet evaporation. In other embodiments, pore size of the membrane is varied to affect sample cluster size or height. The height or thickness for each type of sample spot is not limited.

In general any colloidal particle of mesoscale size suspended in a carrier matrix or in liquid form, of variable concentrations or homogeneity may be printed by the printing head array onto the optical substrate to form a sample spot. Samples can range from collections of plant particles, airborne particulates, or soil particles with dimensions ranging from less than 50 nm to 20 μm; to viscous or concentrated mixtures of proteins or of heterogeneous biomolecules (e.g., saliva, semen, cell lysates) with colloidal or particle dimensions smaller than 50 nm. For examples, samples include but are in no way limited to, plant biomass, crop materials, proteins, airborne particulates, soil or earth samples, water samples, drug samples, viral particles/DNA, microbial samples, any biological or tissue samples, biomolecules, DNA, nucleotides, proteins, enzymes, and printed electronics, etc.

Samples are suspended in a carrier matrix or liquid. A suitable carrier matrix or liquid include but are not limited to water, organic solvents, mineral oil, gels, or other buffer solutions.

MCM as described herein allows researchers to identify important information related to subtle chemical variations within sample composition, by minimizing sample preparation artifacts. In contrast, other techniques are invariably overwhelmed by the noise or measurement error resulting from sample-to-sample variation. In various embodiments, information regarding the classes of chemicals in the array of samples on the MCM plate are captured. In some embodiments, Fourier transform infrared (FTIR) spectral imaging is used. Multiple chemotype analyses can be applied to the samples in a high throughput manner. In various embodiments, to identify the molecules and their abundance in the samples, atmospheric pressure infrared matrix-assisted laser desorption/ionization mass spectrometry imaging (IR-MALDI MSI) is employed. In some embodiments, other chemotype analysis is conducted for further characterization of each sample in the array of samples.

The infrared sources can be thermal emission sources, laser sources, solar, quantum-cascade (QC) lasers or accelerator-based sources (including synchrotrons) of tunable wavelength. In some embodiments, broad-band synchrotron infrared spectroscopic measurement to evaluate the homogeneity and dimensions of the patterns or other parameters including kinetics, microscopy, real time analysis. In other embodiments, benchtop infrared spectrometers may be suitable. In some embodiments the infrared measurements of high-throughput prints are fully automated.

In some embodiments, to determine the classes of chemicals in each “printed” cluster, the MCM plate is “read” by an infrared spectral microscope (i.e., spectromicroscope) using any degree of magnification objective. In some embodiments, a low, medium or high magnification is used. For example, 2× to 15× to 32× to 64× to 75×, etc. magnification is used. In various embodiments, vibrational or IR spectral images are collected and an array of spectra, or so-called hyperspectral data cube, containing spectral information on each sample is collected and analysed. In various embodiments, the infrared light source emits photons in the infrared region (in wavelength from 2.5 μm to 25 μm; in frequency from 4,000 cm⁻¹ to 400 cm⁻¹; in photon energy 0.496 eV to 0.0496 eV).

In various embodiments, after the spectra is collected, univariate and unsupervised analyses is conducted on the infrared spectral data. Suitable analyses include but are not limited to functional group signal integration and/or multiple curve resolution (MCR). The univariate approach, which consists in the integration of the infrared absorbance peak of an individual functional group, is important because it relates the absorbance intensity to the relative concentration of a particular functional class of chemical component through the Beer-Lambert law (the absorption of light is linearly dependent to the analyte concentration). In contrast, the unsupervised approach, like MCR or PCA, can be used to reveal subtle but significant molecular information of the content of the samples instead of individual peaks. For example MCR analysis of infrared absorbance spectra is applied to reveal the distributions of archaea, bacteria, and chemical variations in the samples, which were hidden in the univariate approach.

By combining MCM and the aforementioned approaches, subtle but important information is identified that is directly related to chemical variations within the sample composition and not due to differences in the sample preparation that using other techniques would have been overwhelmed by the noise or measurement error or sample-sample variations.

By analyzing the infrared spectra, MCM can detect and identify the classes of molecules. For some MCM applications, it is desirable to identify the molecules in the samples and the relative quantity. This is achieved by submitting the MCM plate for an additional mass spectrometry analysis, such as atmospheric pressure MALDI (matrix-assisted laser desorption/ionization) MSI (mass spectrometry imaging) with high efficiency and attomole detection limit. The plume of ejected materials is captured by a noncontact surface sampling probe during the laser ablation-induced phase explosion and delivered to electrospray ionization (ESI) and subsequent mass spectrometry analysis (FT/ICR or LTQ Orbitray XL).

Towards Large Scale Research and Industrial Applications:

Since this invention enables the rapid and well-controlled “printing” of uniform patterns of various plant material samples in a reproducible and high-throughput manner, the chemical differences among various energy crops (and their variants) will be screened and characterized accurately (than that obtainable through the convention sample preparation techniques). Existing bioenergy industries will be able to integrate this invention into their procedure for screening and characterizing potential bioenergy crops.

In another embodiment, development of strategies and technologies for scaling up throughput capabilities from screening tens of lines per day to hundreds of mutants per day. In another embodiment, parallel real-time monitoring of the kinetics of microbial deconstruction of microbial organisms such as Brachypodium are enabled by MCM.

In some embodiments, the present system and methods can be used to print solutions, mixtures of solutions and arrays of solutions containing different concentrations of pure biomolecules included, but not limited to, proteins, nucleic acids, lipids and carbohydrates for other applications.

### Example 1

### Fabrication of the Printing Head

Construction of Photomasks for the Fabrication of the Printing Head.

To make the photomask #1 (FIG. 5A), we use a conventional photomask approach to define the UV-exposed area which will be the reservoir area (FIG. 6c) of the printing head (FIGS. 6b and 6c). To make the photomask #2 (FIG. 5A), we used a conventional photomask approach to define the UV-exposed area which will be the pores (FIG. 6a) of the printing head.

Fabrication of Printing Heads for Printing Bioenergy Crop Samples. Step #1:

A piranha cleaned silicon wafer is used for the fabrication of a printing head (FIG. 5C). We typically use wafers of 4- or 6-inch diameter with 500-600 μm thickness. A low-stress silicon nitride film of 100-400 nm thickness is deposited on the front and the back sides (FIG. 6c) of the wafer. A typical deposition process such as the Low-Pressure Chemical Vapor Deposition (LPCVD) is used.

Step #2:

The front side and the back side of the wafer are spin-coated with conventional photoresist, which is baked typically for 1-5 minutes at 90° C.

Step #3:

We use photomask #1 (FIG. 5A) to define the UV-exposed area of the reservoir on the back side of the printing head (FIG. 5C). We use photomask #2 (FIG. 5A) to define the UV-exposed area of the printing pores on the front side of the printing head (FIG. 5C).

Step #4:

UV-exposed area of the photoresist on the front and the back sides are developed by the conventional developer.

Step #5:

The pores on the front side and the reservoir-openings on the back side are produced by RIE (Reactive-Ions-Etching) on silicon nitride films.

Step #6:

The bulk-silicon of the wafer is wet-etched by using wet-etchants such as 5% (v/v) KOH (Potassium hydroxide) in water at 90° C. for 10-20 hours.

Step #7:

After the wet etching procedure is completed, arrays of free-standing silicon nitride membrane with pore patterns (see FIGS. 5D-F) are generated on the printing head. The printing head with the pore patterns is rinsed by water and air-dried.

Step #8:

To enhance the hydrophobicity of the surface of the printing head, its front and back sides are coated with hydrophobic polymers such as FOTS (Fluoroctatrichlorosilane) monolayer by deposition method such as Metal-Organic Chemical Vapor Deposition (MOCVD).

Preparation of Hydrophobic Infrared Transparent/Reflecting Substrates for Printing Bioenergy Crop Particle Suspension. Step #1:

The hydrophobicity of the infrared transparent/reflecting optical substrate surface is essential for the success of sample printing. To enhance the hydrophobicity, we deposit monolayers of FOTS (Fluoroctatrichlorosilane) on the substrate surface using conventional methods including Metal-Organic Chemical Vapor Deposition (MOCVD).

### Example 2

### Preparation and Printing of Bioenergy Crop Particle Suspension

Procedure Development and Demonstration:

High-throughput screening protocol of model bioenergy crop brachypodium is illustrated in FIG. 3. Optimal parameters for brachypodium printing such as the milling/grounding parameters (speed, temperature, duration, vessel materials), carrier fluids/solids, concentration of brachypodium in carrier fluid or solid or mixture of fluid and solid), and pore size of the printing head are identified by infrared spectroscopy of the printed patterns. In this demonstration, we used broad-band synchrotron infrared spectroscopic measurement to evaluate the homogeneity and dimensions of the patterns. The evaluation/optimization was recursively iterated by changing the input parameters until the outcome meets pre-determined criteria. For example, the parameters found for brachypodium powders include concentrations between 5 and 10% of plant cell wall materials, particle size of milled/ground plant materials less than 100 μm and preferably under 5 μm particle size, and preferred carrier matrix of liquids (e.g., water, organic solvents, mineral oil, etc).

After the optimization of the above parameters, high-throughput printing of various brachypodium powders was performed.

Preparation of Bioenergy Crop Particle Suspension. Step #1:

Bioenergy crop materials such as the dried tissues of Brachypodium distachyon (a grass model) are grounded using conventional techniques such as cryo-ballmilling until the sizes of the particles are less than 100 um, preferably under 5 um.

Step #2:

The energy crop particles are dispersed in carrier matrix such as liquid (water, buffer solution)

Printing Bioenergy Crop Particle Suspension onto Infrared Transparent/Reflecting Substrates. Step #1:

Attach the printing head to the existing mask holder of the commercially available contact—photolithography machine (MA/BA6, Suss MicroTec, Germany).

Step #2:

Insert the photomask holder (FIG. 6B, upper component) with the printing head into the aligner (FIG. 6B, lower component).

Step #3:

Use the global printing system (FIG. 6B) to align the printer head with the substrate. This involves placing the infrared transparent or reflecting substrates in the aligner to precisely align the printing head (FIG. 6B, upper component) with the suspension receiving optical substrate.

Step #4:

Load 1-100 μL, of bioenergy crop particle suspension into the reservoir of the printing head. Numerous micrometric meniscus are formed by the balance of gravity- and surface tension of the suspension in the printing head reservoir (from Example 1). Large numbers of picoliter droplets are printed onto the hydrophobic substrate (from Example 2) by lowering the printing head for a complete contact between the pores of the printing head and the substrate (See FIG. 7).

Step #5:

After a contact time of typically less than 1 second, the printing head is lifted up to the starting position (FIG. 7B) to allow for the rapid evaporation of the droplets. Evaporation-driven self-clustering of the energy crop particle is completed within a minute.

Step #6:

Place the optical substrate plate with printed plant/crop particle clusters in desiccators until ready for infrared measurements.

Step #7:

Placed the optical substrate plate to the infrared microscope where the mid-infrared photons emitted from an infrared light source are focused onto the sample. Infrared signal of different wavelength (also called infrared spectra) will be recorded for each printed cluster in the transmission or in the transflectance mode.

Step #8:

The resulting data cube, which consists of sample-associated infrared spectra, is subjected to data preprocessing and processing calculations, including spectrum baseline removal, using both Thermo Scientific Ominc and Matlab. In this example, we removed linear baseline offsets and sample heterogeneous thickness effects using this method. The spectral data in the 900-1800 cm⁻¹ region is then extracted and compressed into low dimensional data arrays using Principal Component Analysis (PCA) algorithm. The compressed spectra of samples that exhibit distinct chemical composition are then detected using multivariate pattern recognition algorithm (Manhattan distance).

### Example 3

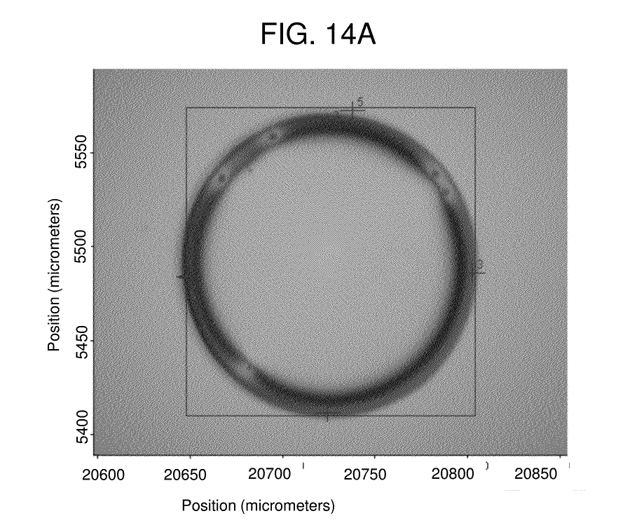

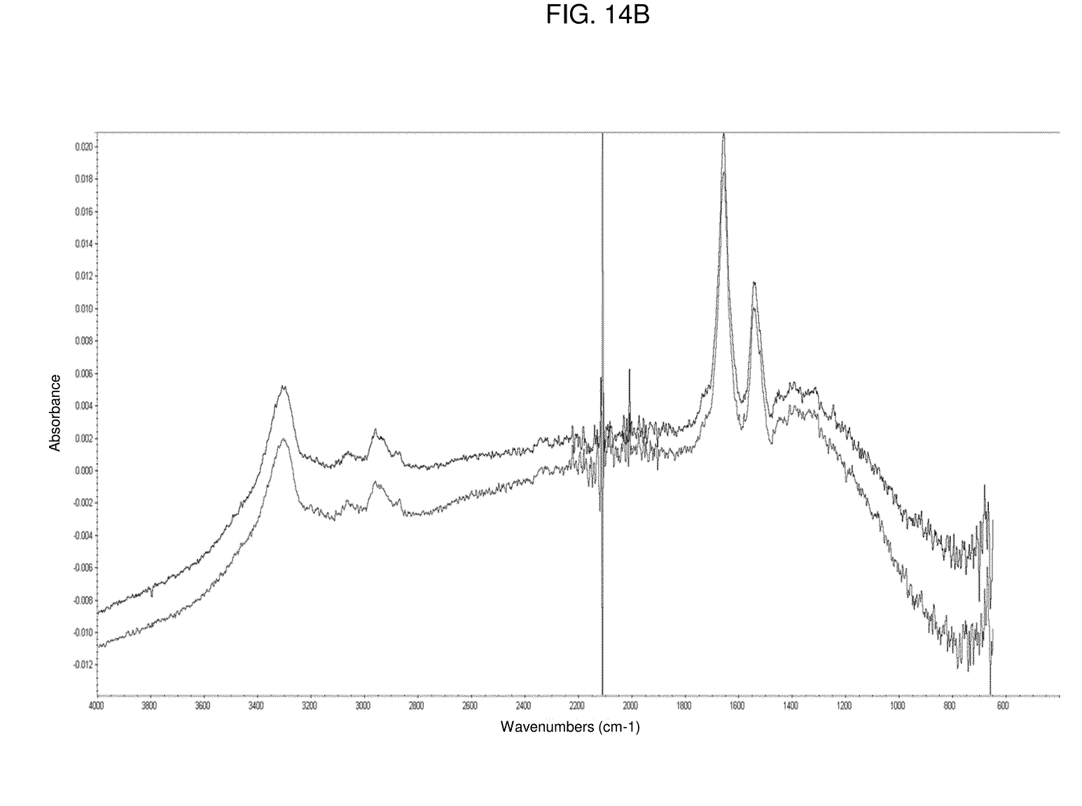

Another example of a high-throughput screening of biomolecules is illustrated the results shown in FIGS. 14A and 14B. Very little sample preparation for protein printing is required as the protein is suspended in a buffer and thus able to be printed.

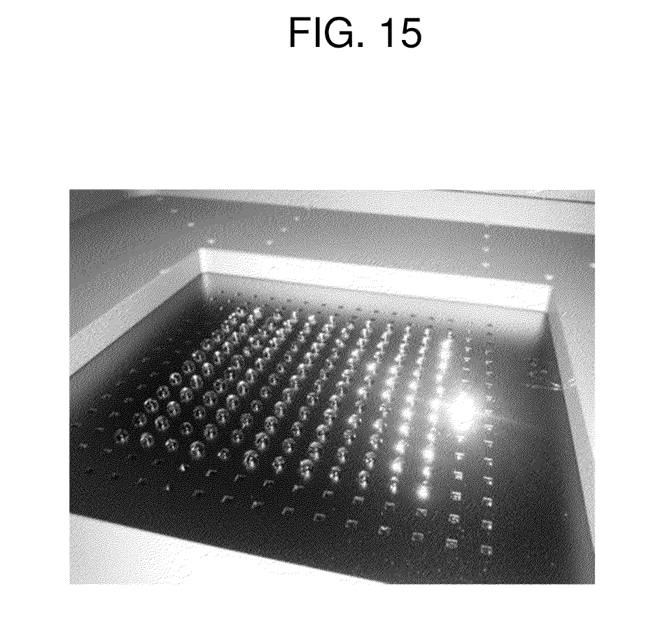

Referring to FIG. 8, the evaluation/optimization is recursively iterated by changing the input parameters until the outcome meets pre-determined criteria. After optimization of the parameters, high-throughput printing of Bovine Serum Albumin (BSA) is performed. In this example, this method is used to build a calibration curve for High-throughput screening protocol for BSA quantification using vibrational spectroscopy, see FIG. 15 for details. Using this technique, picograms of protein can be quantified.

The above examples are provided to illustrate the invention but not to limit its scope. Other variants of the invention will be readily apparent to one of ordinary skill in the art and are encompassed by the appended claims. All publications, databases, and patents cited herein are hereby incorporated by reference for all purposes.

What is claimed is:

1. A MEMS (Micro Electro-Mechanical Systems)-based system for high-throughput screening comprised of a porous membrane printing head array which is back-side etched to feature reservoirs at each pore; an optical substrate plate; a printing system for aligning the head and the optical substrate, wherein the printing head array attached to the printing system.

2. The system of claim 1 wherein the porous membrane printing head array comprised of silicon, silicon nitrides, any inert metal or metal alloy, or any rigid polymer.

3. The system of claim 2 wherein the porous membrane printing head array comprised of silicon and/or silicon nitrides.

4. The system of claim 1 wherein the porous membrane printing head array features pores defined by photolithography and dry etching.

5. The system of claim 1 wherein the optical substrate plate is silicon or glass.

6. The system of claim 1, wherein the optical substrate plate comprised of silicon, metal or alloys, polymer, or other substrate.

7. The system of claim 6, wherein the optical substrate plate is mid-infrared transparent or reflective.

8. The system of claim 7, wherein the optical substrate plate comprising a hydrophobic material or coated with a hydrophobic material.

9. The system of claim 8, wherein the coating is fluoroctatrichlorosilane, Teflon, or any other hydrophobic material.

10. The system of claim 6, wherein the optical substrate plate is coated with a thin layer of chromium or titanium for adhesive purpose, then a thin layer of gold, aluminum, or silver.

11. The system of claim 1 wherein direct contact of the printing head with the optical substrate plate transfers multiple picoliter droplets of particle suspension to the optical substrate.

12. The system of claim 5 wherein the picoliter droplet is 20 pL˜200 pL.

13. The system of claim 1 further comprising a pressure sensor means for sensing and controlling the printing head contact with the optical substrate.

14. A high throughput method for preparing and screening samples comprising the steps of:
a. preparing samples according to standardized sample preparation parameters, said parameters comprising particle size and concentration for an array of samples, for reproducible and accurate vibrational spectroscopic analysis of the array of samples, wherein said samples are suspended in a carrier matrix;
b. loading said prepared samples into reservoirs of a porous membrane printing head array of claim 1;
c. printing said array of samples on a mid-infrared optical substrate plate of claim 1, wherein said printing is carried out by a porous membrane printing head array of claim 1; and
d. multiplex screening of said printed samples by vibrational spectroscopic analysis.

15. The method of claim 8, wherein direct contact of the porous membrane printing head with the optical substrate plate transfers multiple picoliter droplets of sample particle suspension to the optical substrate plate.

16. A method of preparing and screening for bioenergy plant materials comprising the steps of:
a. standardizing the sample preparation parameters of particle size and concentration for an array of bioenergy plant materials samples for reproducible and accurate vibrational spectroscopic analysis of the array of samples;
b. preparing the samples according to said parameters determined in previous step;
c. loading said prepared samples into reservoirs of a porous membrane printing head array of claim 1;
d. printing said array of samples on a mid-infrared optical substrate plate of claim 1, wherein said printing is carried out by a porous membrane printing head array of claim 1
e. evaluating the printed array of samples for homogeneity and thickness of the printed samples against a standard reference, wherein if said printed samples are do not meet the standard, steps c and d are reiterated; and
f. screening of said printed samples by vibrational spectroscopic analysis and/or other chemotype analysis.
